(19) United States
(12) Patent Application Publication
(10) Pub. No.: US 2009/0030618 A1
(43) Pub. Date: Jan. 29, 2009

(54) SYSTEM, METHOD AND SOFTWARE ARRANGEMENT FOR ANALYZING AND CORRELATING MOLECULAR PROFILES ASSOCIATED WITH ANATOMICAL STRUCTURES

(75) Inventors: Leo L. Cheng, Andover, MA (US); Bruce Jenkins, Belmont, MA (US); Chen-Lee Wu, Newton, MA (US); Guangping Dai, Action, MA (US); Elkan F. Halpern, Newton, MA (US)

Correspondence Address: QUARLES & BRADY LLP, 411 E. WISCONSIN AVENUE, SUITE 2040, MILWAUKEE, WI, 53202-4497, US

(73) Assignee: The General Hospital Corporation, Boston, MA (US)

(21) Appl. No.: 11/911,469

(22) PCT Filed: Apr. 11, 2006
(86) PCT No.: PCT/US06/13517

§ 371 Date: Aug. 12, 2008

Related U.S. Application Data
(60) Provisional application No. 60/670,391, filed on Apr. 12, 2005.

(51) Int. Cl. G06F 19/00

(52) U.S. Cl. 702/19

(57) ABSTRACT

A system, method and software arrangement according to exemplary embodiments of the present invention are provided which can use molecular profiles obtained from unaltered human tissue specimens for clinical purposes including disease diagnoses and treatment evaluations. For example, spatial distributions of chemical species including metabolites within the tissue may be obtained using radiological techniques such as magnetic resonance spectroscopy imaging. Disease-specific profiles may be obtained by comparing the distributions of chemical species obtained in ex vivo tissues with pathological observations made on them using statistical analysis. The disease-specific profiles may then be correlated with in vivo or ex vivo molecular profiles to obtain spatial maps that can provide a more sensitive and accurate detection of diseased tissue. Thus, such exemplary systems, methods and software arrangements can include the ability to receive information relating to the distribution of at least three chemical species in the tissue of interest, compare this information statistically to a predetermined profile and, based on the statistical correlation between the information and the profile, determine certain characteristics of the tissue of interest such as, e.g., the presence or absence of diseased tissue.

### CROSS-REFERENCE TO RELATED APPLICATION(S)

This application claims priority from U.S. patent application Ser. No. 60/670,391, filed Apr. 12, 2005, the entire disclosure of which is incorporated herein by reference.

### GOVERNMENTAL SUPPORT

The research leading to the present invention was supported, at least in part, by the United States National Institute of Health (NIH) under Grant number R01CA095624, and by the United States Department of Defense (DOD) under Grant number W81XWH-04-1-0190. Thus, the U.S. government may have certain rights in the invention.

### FIELD OF THE INVENTION

The present invention relates to a system, method and software arrangement for analyzing and correlating molecular profiles associated with anatomical structures. More particularly, the profiles can be obtained using radiological methodologies and other in vivo analytical techniques for clinical uses, including but not limited to disease diagnoses and treatment evaluations.

### BACKGROUND INFORMATION

Magnetic resonance spectroscopy (MRS) technologies can be used to detect the presence and concentration of various chemical species, such as metabolites, in a homogeneous magnetic field. These techniques may be utilized to determine a presence of chemical species in living tissues non-invasively, which can assist in evaluating physiological or pathological conditions present. Techniques for measuring metabolite concentrations in bodily tissues are described, e.g., in U.S. Pat. No. 5,500,592.

Magnetic resonance imaging (MRI) techniques, which are widely used diagnostic radiology tools, are derived (in part) from MRS. MRI can be used to measure a single chemical, e.g., water, in an artificially-created inhomogeneous magnetic field. The inhomogeneity of the magnetic field generally allows for a detailed imaging of anatomical structures and tissues that can be presented as two-dimensional cross sections. Such cross sections may be combined to provide a three-dimensional mapping of tissue structures within the structures/tissues.

Combining the spectroscopy principles with the imaging capabilities developed over the past two decades for MRI technology presents the possibility of non-invasively measuring metabolic molecules in living tissue, and has led to the development of in vivo MRS and, more recently, to the generation of magnetic resonance spectroscopy imaging (MRSI) techniques for a diagnostic radiology. For diagnostic purposes, MRSI data (in the form of either single metabolite concentrations or simple ratios of the concentrations of two metabolites) have been mapped onto morphological MR images to determine the presence of metabolites within specific structures/tissues.

High-resolution magic-angle spinning (HRMAS) proton MRS is a technique that has been developed for an intact tissue analysis. Magic-angle spinning, generally used to reduce a resonance line-width in solid-state nuclear magnetic resonance (NMR) analyses, can subject sample structures/tissues to mechanical rotations in a kilohertz range at the “magic angle” of 54°44′ from the direction of the spectrometer's static magnetic field while spectroscopy is recorded. When applied to intact tissues, HRMAS can produce highly-resolved spectra, allowing an identification of individual metabolites while preserving tissue pathological morphology. HRMAS techniques are described, e.g., in Cheng L L et al., “Enhanced resolution of proton NMR spectra of malignant lymph nodes using magic-angle spinning,” Magn Reson Med, 1996; 36:653-8.

Prostate specific antigen (PSA) screening is a technique that can permit increased detection of prostate cancer at early stages. However, this histopathology technique alone generally may not reliably direct an appropriate treatment. The utility of PSA testing in detecting clinically significant prostate tumors has been clinically shown. However, there is a significant incidence of ‘indolent’ cancers in PSA screening of certain populations. The inability of a PSA screening technique to distinguish ‘indolent’ from ‘aggressive’ carcinomas can result in adverse consequences of over-treatment.

The Gleason Score (GS) is a widely adopted histological grading system/technique for a prostate biopsy. This system/technique is described in, e.g., Gleason D., “Classification of prostatic carcinomas,” Cancer Chemother Rep 1966; 50:125. For example, such a system/technique generally assigns the tumor two grades from 1 to 5, one to primary (dominant) and one to secondary (sub-dominant) tumor growth patterns. The sum of the two numbers (between 2 and 10) determines a tumor score. A value of 2 to 4 for the score is considered a “well-differentiated disease,” whereas a value of 5 to 7 for the score indicates “moderately differentiated adenocarcinomas,” and a value of 8 to 10 for the score denotes “poorly differentiated cancers.” A higher score signifies greater probability of tumor extracapsular spread, nodal involvement, and metastases. However, more than 70% of cancers now diagnosed with PSA tests are GS 6 and 7 tumors, which generally may not be further sub-categorized without an additional surgical intervention (i.e., prostatectomy) to assess tumor virulence, and clinical outcomes for these patients have differed significantly.

Clinical and histopathological determinations from prostatectomy can be used to obtain or calculate another parameter, i.e., the stage of tumor, node, and metastasis (TNM) according to the American Joint Commission on Cancer (AJCC). This classification is described, e.g., in Carroll P, Lee K, Fuks Z, Kantoff P., “Cancer of the Prostate,” in: DeVita V, Hellman S, Rosenberg S, editors, Cancer: Principle and Practice of Oncology, 6th ed., Philadelphia: Lippincott Williams & Wilkins; 2001.

Although prostate tumor grade and stage can be determined independently, they are often intrinsically related. However, it can be difficult to distinguish aggressive from indolent cancers, individually, even with the assistance of empirical nomograms. Therefore, the proper treatment course for the majority of patients (having a GS of 6-7) may be difficult to determine. Clinical evidence generally shows that the outcome for some patients of this group is satisfactory, while it is poor for other patients. Tumor aggressiveness, manifested in bioactivities, may be responsible for the variability of observed outcomes among individuals initially diagnosed with GS 6 or 7 tumors. Therefore, modalities for quantifying the biological characteristics of tumor aggressiveness are needed.

The limited prognostic insight of such clinical measures such as PSA, GS, and digital rectal exams often leads to either unnecessarily aggressive or dangerously conservative treatment. For example, radical prostatectomies can result in impotence and/or incontinence of urine. Prostate tumor heterogeneity can further impair the usefulness of histopathology in comprehensive evaluations, as prostate cancer cells may elude biopsy analysis, producing false negative results.

Accordingly, more reliable and informative prognostic tools are needed.

### SUMMARY OF EXEMPLARY EMBODIMENT OF THE INVENTION

According to the present invention, exemplary systems and methods are provided for improved diagnosis and treatment evaluations based on, e.g., in vivo analysis of bodily tissues based on magnetic resonance technology. For example, systems, methods and software arrangements are provided for accurately detecting and diagnosing diseases, including cancer, by comparing the detected levels of a plurality of molecules such as, e.g., metabolites, with disease- or condition-specific metabolomic profiles or maps.

Exemplary embodiments of the present invention relate to a concept that in a biological system, such as a human body, various metabolite processes or pathways are interconnected. Thus, alterations of the overall metabolite profiles (e.g., metabolomics) may be more sensitive and specific to a particular physiological and/or pathological condition than the change in any single metabolite or in the ratio of any two metabolites. This concept is similar to the correlation of genomic profiles that are based on thousands of genes on a microarray to identify the presence or propensity for a particular disease condition to manifest, rather than the disease or condition being based on the expression of only one or two genes.

Certain exemplary embodiments of the systems, methods and software arrangements in accordance with the present invention can utilize an objective modality capable of sensitively measuring unaltered human tissue specimens for cancer-related changes in metabolic profiles, without destroying pathological structures.

In further exemplary embodiments of the present invention, in vivo disease detection may be achieved by comparing a plurality of measured metabolite parameters to specific profiles that may be indicative of the presence of the disease. Such profiles may be constructed or defined, for example, by ex vivo MRS measurements of a cancerous tissue, and a comparison of the observed metabolite profiles with those obtained from surrounding healthy tissue. Metabolomic profiles may then be constructed using statistical analysis to yield a strong correlation between combinations of individual metabolite profiles, and the presence or absence of a specific disease or condition.

For example, in vivo chemical shift imaging (CSI) or MRSI techniques may be used to obtain a MRS measurement for each voxel in the tissue region of interest. These measurements may then be compared to a particular metabolomic profile (e.g., a linear combination of certain measured metabolites established previously using ex vivo analysis) that corresponds to a specific condition. The voxel MRS data may be processed to produce a parameter indicating the correlation between the measured metabolite levels and the metabolomic profile. This parameter can be mapped onto a corresponding 2D or 3D morphological image. The voxels having metabolite concentrations that are highly correlated with the metabolomic profile can indicate regions of tissue having a heightened degree of disease involvement.

In still further exemplary embodiments of the present invention, other molecular measurements, including but not limited to genomic and proteomic measurements, may be compared to corresponding profiles in a manner similar to that described above for metabolomics. Such measurements can be made using modalities other than the magnetic resonance spectroscopy including, but not limited to, MRI, perfusion and diffusion MRI, genomic based molecular imaging, mass spectroscopy, optical spectroscopy, CT, or any other radiological or analytical technique that may be used in a clinical setting.

In yet further exemplary embodiments of the present invention, metabolite levels measured with magnetic resonance spectroscopy may be combined with measurements of other molecular species, and the results can be compared to combined disease-specific metabolomic and molecular profiles. Thus, numerically measurable parameters other than those produced by metabolomics can also be included in the disease-specific molecular profiles, and used for an evaluation of measured tissue concentrations, if their inclusion improves the overall accuracy of disease identification.

In further exemplary embodiments of the present invention, an analysis of metabolites or other molecules measured ex vivo in a surgically removed organ may be compared to metabolomic or other profiles to assist pathologists in identifying, e.g., some or all of the cancerous or diseased regions within the removed tissue, and in predicting overall patient pathological status that cannot be achieved currently and clinical at a biopsy stage. An example can be an analysis of a prostate biopsy specimen, which may be performed to ensure a more accurate diagnosis.

These and other objects, features and advantages of the present invention will become apparent upon reading the following detailed description of embodiments of the invention, when taken in conjunction with the accompanying figures showing illustrative embodiments of the invention and the appended claims.

### BRIEF DESCRIPTION OF THE DRAWINGS

FIG. 1 is a is a flow diagram of an exemplary embodiment of a method according to the present invention;

FIG. 2A is an illustration of an exemplary HRMAS spectrum obtained from a sample of intact prostate tissue;

FIG. 2B is a cross-sectional image of a prostate tissue sample used for a histopathology analysis;

FIG. 3 is an exemplary three-dimensional plot of detected chemical species correlated with pathological observations in prostate tissues in accordance with an exemplary embodiment of the present invention;

FIG. 4 is an exemplary canonical plot resulting from a discriminant analysis of the three variables shown in FIG. 3 in accordance with an exemplary embodiment of the present invention;

FIG. 5 is an exemplary graph of a receiver operating characteristic curve corresponding to the plot shown in FIG. 3;

FIG. 6A is an exemplary plot showing a correlation of the metabolite phosphocholine with pathological observations in prostate tissues;

FIG. 6B is an exemplary plot showing a correlation of the metabolite choline with pathological observations in the prostate tissues;

FIG. 7 is an exemplary plot showing a correlation of serum PSA levels with principal component 2 measured in histo-benign prostate tissues;

FIG. 8A is an exemplary plot showing a correlation of measured levels of principal component 2 with tumor stages in the prostate tissues;

FIG. 8B is an exemplary plot showing a correlation of measured levels of principal component 5 with tumor stages in the prostate tissues;

FIG. 8C is an exemplary plot showing a correlation of measured levels of principal component 2 with tumor stages in prostate tissues having a Gleason score of 6 or 7;

FIG. 8D is an exemplary plot showing a correlation of measured levels of principal component 5 with tumor stages in prostate tissues having a Gleason score of 6 or 7;

FIG. 9 is a high-resolution image of a removed cancerous human prostate that includes benign structures;

FIG. 10 is a block diagram of an system in accordance with exemplary embodiments of the present invention;

FIG. 11A is an exemplary matrix of spectral peak intensities;

FIG. 11B is an exemplary matrix of principal component (PC) coefficients determined from the peak intensities shown in FIG. 11A;

FIG. 11C illustrates an exemplary calculation that may be used to determine the PC coefficients; and

FIG. 12 illustrates the configuration of a phantom study of three metabolite solutions of varied concentrations together with the in vivo and ex vivo spectra obtained from these solutions.

### DETAILED DESCRIPTION OF EXEMPLARY EMBODIMENTS

Systems, methods and software arrangements according to exemplary embodiments of the present invention may be used to analyze and evaluate molecular profiles measured in two- or three-dimensional radiological images for the purpose of clinical uses including, but not limited to, disease diagnoses and treatment evaluations. For example, using such exemplary embodiments, issue metabolomic or molecular profiles can be used to differentiate cancer or other conditions from histologically benign tissues. The use of profiles that include a plurality of detectable metabolites and/or molecules can be more accurate for detection of cancer or other diagnoses than conventional single-metabolite maps obtained using, e.g., MRSI, which may be based only on the presence or concentration of a single measurable metabolite or molecule.

For example, changes in tumor metabolism, downstream from genomic and proteomic transformations, may reflect disease-related biochemical reactivity, and can precede histologically observable changes in cell morphology. Detection and analysis of metabolite and molecular concentrations associated with such changes can offer an early way for predicting tumor behaviors.

With the assumption of the existence of disease specific metabolomic profiles, these exemplary embodiments of the present invention can be utilized. For instance, a conventional MRI scanner with CSI or MRSI capability can be used to convert the current CSI single spectrum for each voxel into metabolomic maps for different pathological interests with an addition of a converting subroutine.

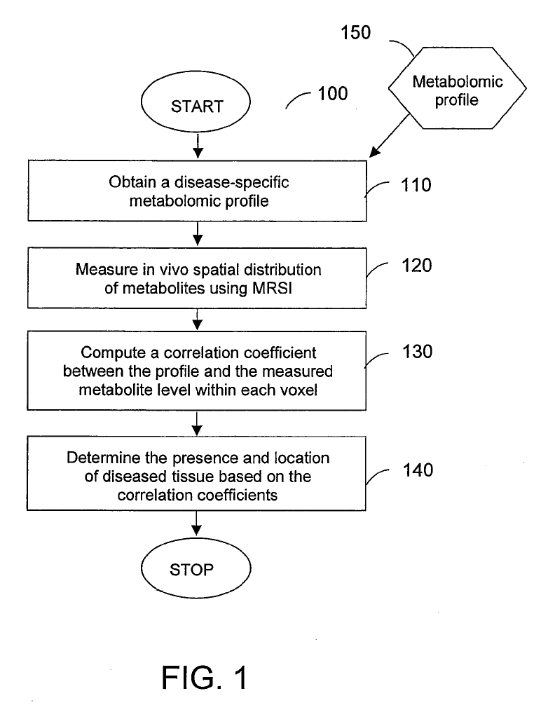

FIG. 1 illustrates a flow diagram of an exemplary method 100 according to certain embodiments of the present invention. This exemplary flow diagram provides exemplary steps that may be used to obtained improved detection and diagnosis of diseased tissue within an anatomical structure. For example, a disease-specific metabolomic profile can first be obtained (step 110). This profile may include the local presence, absence, concentration, and/or concentration ratios of a plurality of detectable metabolites that may be characteristic of the diseased tissue. Disease-specific metabolomic and/or molecular profiles that may be used with exemplary embodiments of the present invention can be established using an ex vivo analysis of diseased and healthy tissue specimens. Other detectable chemical species may also be included in these profiles. Multiple profiles, each of which may be associated with a different disease or condition, can be used in a single diagnostic analysis of a patient. Once a particular profile is obtained, it may be subsequently employed for detection of the corresponding disease or condition on any number of patients.

Metabolite distributions in the tissue being examined can then be determined using MRSI techniques (step 120). The distributions can be measured for each metabolite and/or other chemical species that are included in the profile being used. If more than one profile is being used to simultaneously detect the presence of more than one disease or condition, each metabolite or chemical species included in each profile used may be measured. The distributions may be determined using conventional analytical procedures. This can be achieved by detecting the concentration of a metabolite or species within each voxel, or volume element, targeted or scanned by the MRSI equipment or other detection apparatus. Other detection methods may be used instead of or in addition to MRSI techniques to obtain spatial distributions of metabolites and/or other species. Such detection methods can include, but are not limited to, perfusion and diffusion MRI, genomic-based molecular imaging, mass spectroscopy, optical spectroscopy, CT, or other radiological or analytical techniques.

A local correlation factor for the selected metabolomic profile may then be calculated or otherwise determined by a statistical comparison of the profile with the detected levels or concentrations of metabolites or other chemical species. This correlation factor may be determined for each voxel or other volume of tissue analyzed (step 130). The calculation can be performed using a modification of the routines that are used in some analytical equipment to calculate single-metabolite maps. The correlation factor can be determined as a statistical match to the selected metabolomic profile, which may be expressed as a linear combination of concentrations and/or concentration ratios of single-metabolites or other chemical species.

The correlation of the detected metabolite and/or chemical species concentrations with the selected profile can be displayed or presented as a spatial distribution of the local calculated correlation parameters. This distribution can be overlaid onto a morphological image of the tested tissue. Using such representation of the correlation parameter, diseased regions of tissue may be identified as those exhibiting a high correlation with the selected profile (step 140). Tissue regions that exhibit concentrations of a plurality of metabolites and/or chemical species that are strongly correlated with profiles characteristic of the diseased tissue thus can provide an indicator that the tissue may be diseased. Such a correlation based on a plurality of metabolites and/or chemical species can be a more accurate and reliable indicator that the tissue is likely diseased or benign over the diagnostic methods that are based on the local concentration of a single metabolite or species.

A metabolomic profile 150 or other disease- or condition-specific profile can be provided for use by the exemplary method 100 to allow for a detection of the disease or condition in the tissue being examined. Such profiles may be determined only once (or more than once) for each disease or condition, and may be used in subsequent analyses of many patients. Each profile can be determined using statistical analysis, such as the principal component analysis approach described hereinbelow. The analysis can be performed by correlating the concentrations or relative amounts of two or more detectable chemical species in a tissue sample with one or more characteristics of the tissue sample evaluated by other techniques, such as quantitative morphology of cross sections. The tissue sample can be in vivo when analyzed with localization techniques, or ex vivo, such as a biopsy sample or a removed bodily organ. Several profiles can be formulated for a single disease or condition. These profiles may be based on the same, distinct, or overlapping sets of chemical species such as metabolites.

### EXAMPLE

As an example, an investigation was performed to assess the sensitivity of local prostate metabolites in predicting prostate cancer status using the system, method and software arrangement according to exemplary embodiments of the present invention. 199 prostate tissue samples were obtained from 82 prostate cancer patients after prostatectomy. Prostate metabolite profiles were measured with intact tissue high-resolution magic angle spinning (HRMAS) proton MRS at 14. IT, and further analyzed with quantitative pathology.

Prostate metabolite profiles obtained from principle component analysis (PCA) of tissue spectra were correlated with pathology quantities and with patient serum PSA levels using a linear regression analysis. These correlations were evaluated against the pathological status of each patient using statistical analysis of variance (ANOVA).

Paired-t-tests indicated that tissue metabolite profiles can differentiate malignant from benign samples obtained from the same patient (p<0.005), and that these results correlate with patient serum prostate-specific antigen (PSA) levels (p<0.006). Metabolite profiles obtained from histologically benign tissue samples of GS 6-7 prostates can delineate a subset of less aggressive tumors (p<0.008) and predict tumor perineural invasion within the subset (p<0.03). These results indicate that MRS metabolite profiles of biopsy tissues may help to direct treatment plans by providing more accurate assessment of prostate cancer pathological stage and aggressiveness. Such assessment can be determined conventionally using histopathological methods only after a prostatectomy is performed.

A more detailed description of this application of diagnostic methods in accordance with certain exemplary embodiments of the present invention is provided below.

The patient population and individual prostate tissue samples were characterized by Gleason Score (GS) as: GS 5 [2 cases, 5 samples]; GS 6 [51 cases, 126 samples]; GS 7 [21 cases, 53 samples]; GS 8 [4 cases, 9 samples]; and GS 9 [4 cases, 6 samples]. The patient population was also characterized by the American Joint Committee on Cancer/Tumor-Node-Metastasis (AJCC/TNM) stages (6^{th} ed.) as: T2ab [24 cases, 59 samples]; T2c [44 cases, 112 samples]; T3a [10 cases, 17 samples]; T3b [3 cases, 5 samples]; and T3ab [1 case, 6 samples]. The few T3a, T3b and T3ab cases identified were combined and collectively labeled in the study as T3. Surgical tissue samples were snap-frozen in liquid nitrogen and stored at −80° C. until MRS analysis was performed. Patient clinical statuses were obtained from pathology reports.

A Bruker (Billerica, Mass.) AVANCE spectrometer operating at 600 MHz (14.1 T) was used for all MR experiments. Tissue samples were placed into a 4 mm rotor with 10 μl plastic inserts. 1.0 μl of D₂O was added for field locking. Spectra were recorded at 3° C. with the spectrometer frequency set on the water resonance, and a rotor-synchronized DANTE experimental protocol was applied with spinning at 600 and 700 Hz (±1.0 Hz). 32 transients were averaged at a repetition time of 5 s.

The resulting spectra were processed with AcornNMR-Nuts (Livermore, Calif.) using the following procedures: 0.5 Hz apodization before Fourier transformation, baseline correction, and phase adjustment. Resonance intensities used were determined by calculating integrals of curve-fittings with Lorentzian-Gaussian line-shapes measured from either 600 Hz or 700 Hz HRMAS spectrum.

Following the spectroscopy analysis, samples were fixed in 10% formalin, embedded in paraffin, cut into 5 μm sections at 100 μm intervals throughout the entire sample, and stained with hematoxylin and eosin.

An Olympus BX41 Microscope Imaging System (Melville, N.Y.), in conjunction with the image analyzer SoftImaging-MicroSuite™ (Lakewood, Colo.), was used to quantify sample cross-sections. The areal percentage of cancer cells, normal epithelial cells, and stroma were independently estimated for each cross-section to the nearest 5%. The volume percentage of these features was calculated from the sizes of the cross-sections and the corresponding areal percentage of each pathological feature within each cross section.

Analysis of the spectroscopy and cross-sectional results was performed to correlate spectral metabolite profiles with tissue pathologies and patient clinical statuses. Prior to investigating such correlations, the metabolite matrix was subjected to statistical data treatment in the form of a principal component analysis (PCA) to reduce the complexity of spectral data.

Because certain pathological processes can manifest simultaneous changes in several measurable metabolite levels, a change in concentration of a single metabolite may not accurately represent a specific underlying process. PCA attempts to identify principal components (PCs), which are combinations of the measured concentrations, that may indicate distinct pathological processes if they exist in the set of the samples. A positive contribution of a certain metabolite, for example, can indicate the elevation of the metabolite within the component (process), whereas a negative contribution can suggest a suppression of the metabolite.

The components can then be ordered by the extent to which they are associated with variability in the observed cases. If more metabolites are affected by a biological mechanism (i.e., a greater number of metabolites are associated with a particular PC), the association is greater. A stronger change in the metabolite level caused by a biological mechanism also yields a greater association. Additionally, the incidence of a process can be a factor in the associated variability. Extremely rare and extremely common biological mechanisms cause little variability, whereas biological mechanisms that are seen in approximately half of the cases have the greatest variability associated with them.

Principal components (PCs) may differ from the actual underlying biological mechanism in one important respect. PCs are independent, whereas actual biological mechanisms may affect some common metabolites. For example, one biological mechanism may elevate metabolites A, B, C, and D, while suppressing E and F. A second biological mechanism might elevate A and B, while suppressing C, D, E, and F. As both biological mechanisms affect metabolites A, B, E and F in the same way, it is likely that the PCA results may identify a strong component, expressing an elevation of A and B with the simultaneous suppression of E and F. Another possibly weaker component can express metabolites C and D, and may distinguish the first biological mechanism from the second.

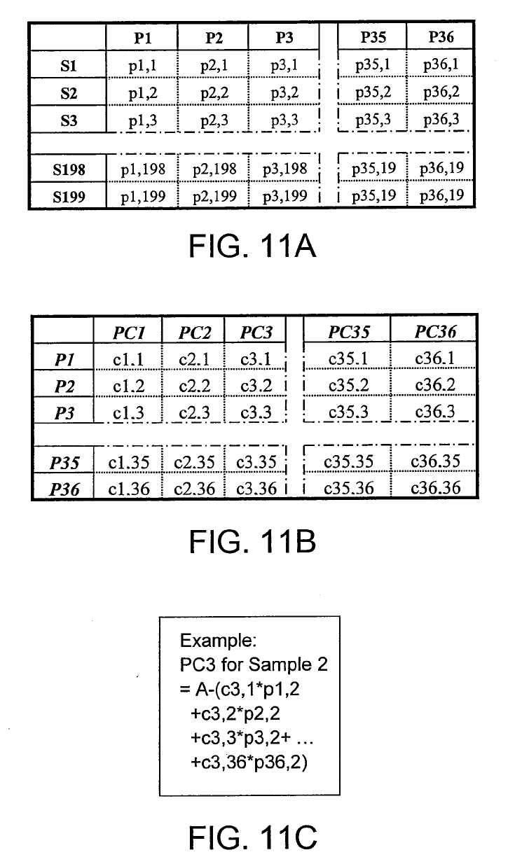

Principle component (PC) analysis was performed on the spectra obtained from the prostate tissue samples as described above. Details of the PCA procedure are illustrated in FIGS. 11A-C. In this exemplary procedure, 199 biological tissue samples were obtained from 82 prostatectomy cases. The metabolites associated with the 36 strongest peaks were identified. FIG. 11A illustrates part of a peak intensity matrix of 199 (number of samples)×36 (number of analyzed metabolites). Each matrix value px,y indicates the peak intensity for each identified peak x as measured in sample y. These values were then converted into a PC coefficient matrix of 36 (number of metabolites)×36 (number of PCs). A portion of this PC coefficient matrix is shown in FIG. 11B. FIG. 11C illustrates an exemplary calculation used for determining the PC coefficients of FIG. 11B. This exemplary analysis resulted in the identification of 15 principal components (PC1 to PC15) having an eigenvalue greater than 0.5. Details of this study and identification of the principal components are described, e.g., in Cheng L L, Burns Mass., Taylor J L, He W, Halpem E F, McDougal W S, Wu C L, “Metabolic characterization of human prostate cancer with tissue magnetic resonance spectroscopy,” Cancer Res 2005; 65(8):3030-3034.

Different metabolite profiles associated with different prostate pathological features (e.g., volume percent of epithelia, cancer cells or stroma) can thus be assessed using a linear regression analysis against these PCs. Paired Student t-tests were used to evaluate the ability of cancer-related PC13 and its major, contributing metabolites, phosphocholine (PChol) and choline (Chol) to differentiate cancerous tissue from histologically benign samples obtained from the same patient. Discriminant analyses were used to generate a canonical plot to achieve the maximum separation between the two groups, with accuracy being analyzed by receiver operating characteristic curves. These analyses are described, e.g., in McNeil B J, Keller E, Adelstein S J. “Primer on certain elements of medical decision making,” N Engl J Med 1975; 293: 211-5. Student t-tests were used to investigate the relationship between cancer-related PC14 and tumor perineural invasion. The abilities of PC2 and PC5 to differentiate between pathological stages were tested using ANOVA. Statistical analyses were carried out using SAS-JMP (Cary, N.C.).

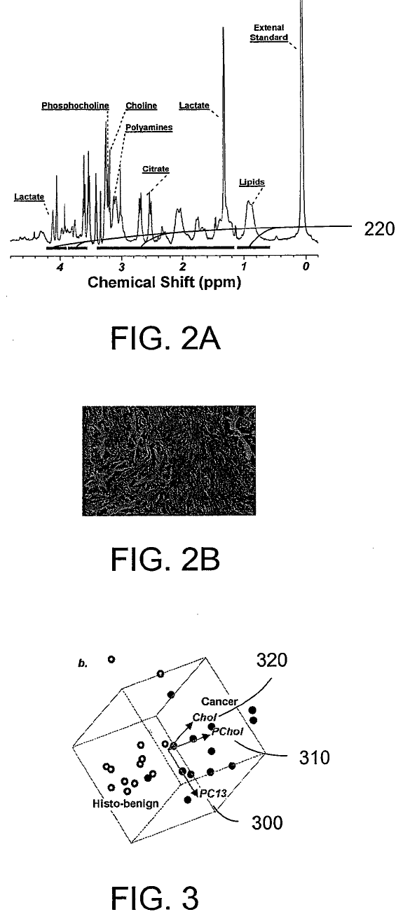

The HRMAS MRS technique permits the acquisition of high-resolution proton spectra from intact tissue while preserving tissue architectures for subsequent histopathological analysis. FIG. 2A shows an exemplary illustration of a High-Resolution Magic Angle Spinning (HRMAS) 1H MR spectrum. This spectrum was obtained from intact tissue from the removed prostate of a 61 y.o. patient with Gleason score 6, T2b tumors. A cross-section of this tissue is shown in FIG. 2B. Histopathology analysis of this tissue sample image after spectroscopy measurement indicated that the sample contained 40% histopathologically defined benign epithelium and 60% stromal structures, with no identifiable cancerous glands. The 36 most intense resonance peaks or metabolite groups above the horizontal bars 220 were selected for analyses, while the other regions were excluded from calculation, partly due to surgery-related alcohol contamination. Select cellular metabolites are labeled on the spectrum shown in FIG. 2A.

Conventional methods used prior to HRMAS techniques to achieve high-resolution metabolite profiles included analysis of metabolites after extraction from the samples by chemical solutions, so that the results were sensitive to the applied procedures including completeness of the extraction step. Tumor heterogeneity also limited the usefulness of such extraction methods.

Histomorphological evaluations can be important for an appropriate interpretation of spectroscopic data obtained from tissue samples. In the exemplary procedure described herein, 20 out of 199 analyzed samples from prostate cancer patients contained cancerous glands, while the remaining 179 samples represented histologically benign tissue obtained from cancerous prostates. These observations reflect the infiltrative, heterogeneous nature of prostate cancer. Thus no visible mass may be produced, and the morphology precludes cancer-selective removal of tissue. These factors help to account for the clinical complexity of prostate biopsy.

The PCA procedure was carried out on the concentrations of the 36 most intense resonance peaks or groups assigned to specific metabolites in order to generate PCs representing different variations of tissue metabolite profiles. Because pathological variations were observed among the samples, it is possible that certain PCs may be able to identify these variations. For example, PC2 (reflecting changes in polyamines, citrate, etc.) was found to differentiate epithelia from stroma with statistical significance (16.5% of variance; epithelia: r=0.381, p<0.0001; stroma: r=−0.303, p<0.0001). Moreover, both PC13 and PC14 were found to differentiate cancer from stroma (cf. PC 14 represents 1.54% of variance; cancer: r=−0.160, p=0.0243; stroma: r=0.217, p=0.0021). The difference of variance representation (16.5% vs. 1.54% of the total variability of the standardized 36 metabolites for PC2 and PC 14, respectively) is consistent with the observation that only 10% of the samples were identified as cancer-positive, while more than 90% of them were designated epithelium-positive. Not all PCs may be related with the evaluated pathologies. Many principal components may indicate intrinsic differences that are not evaluated, or they may indicate variables such as, e.g., spectrometer instabilities that are not relevant to the establishment of metabolomic profiles.

Histologically-defined cancer-absent (histo-benign) samples were analyzed from 13 out of 18 patients from whom histologically cancer-positive samples were also analyzed. The three-dimensional plot shown in FIG. 3 of PC 13 (300) versus PChol (310) and Chol (320) indicates a separation between the cancerous and histo-benign groups on a plane of observation. Both of these metabolites, PChol (310) and Chol (320), were found to be the major contributors to PC13 (300) and PC 14. This observation is consistent with current descriptions in the literature associated with the MRS technique of their in vivo and ex vivo relationship with malignancy. See, e.g., Podo F. “Tumour phospholipid metabolism,” NMR Biomed 1999; 12: 413-39. The paired Student's t-test (cancer vs. histo-benign from the same patients) results for PC13 (300), PChol (310) and Chol (320) were found to be 0.012, 0.004 and 0.001, respectively.

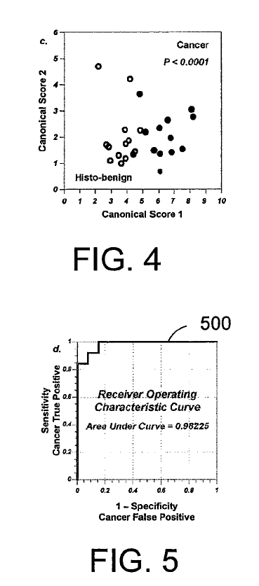

Additionally, both PC13(300) and PC14 were found to be linearly correlated (p: 0.04, 0.02) with the observed volume percentage of cancer cells. Application of discriminant analysis to the three variables PC13 (300), PChol (310) and Chol (320) in FIG. 3 indicated a classification accuracy of about 92.3%. These results are shown in a plot of FIG. 4, which presents the maximum separation between the cancer and histo-benign groups of samples, which was obtained by this particular two-dimensional projection of a three-dimensional plot. An overall accuracy of about 98.2% for the identification of cancer samples was obtained from a receiver operating characteristic (ROC) curve generated from the three variables. This curve 500 is illustrated in FIG. 5. The curve 500 indicates the high degree of accuracy that can be achieved by using the three variables plotted in FIG. 3 to positively identify cancer samples.

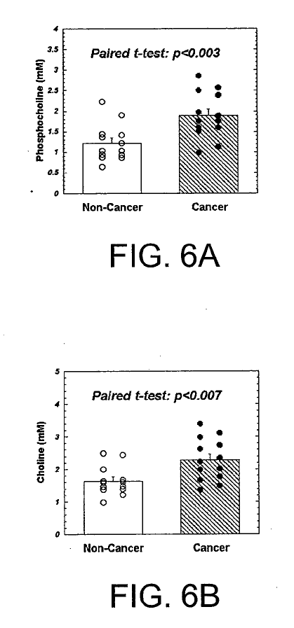

FIGS. 6A and 6B show illustrations of the observed levels of the single metabolites PChol (310) and Chol (320), respectively, in benign and cancerous specimens. In contrast to the metabolomic correlations shown in FIGS. 3-5, the single-metabolite results indicate a much lesser correlation with the observed pathological condition. The illustrations provided in FIGS. 6A and 6B verify that pathological conditions can be determined more accurately using metabolite profiles than with single metabolite measurements.

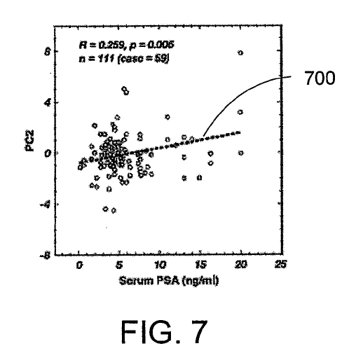

Of the 82 prostatectomy cases studied, patient serum PSA levels prior to surgery were available for 59 of them. 111 histo-benign tissue samples were identified from different prostate zones (central, transitional, and peripheral) of these 59 cases. An evaluation of the relationship between PSA levels and tissue metabolite profiles indicated that PC2 was linearly correlated, with statistical significance, to PSA results. This correlation 700 is illustrated in FIG. 7. Because PC2 was observed to be linearly correlated with the volume percentage of histo-benign epithelial cells, any correlation observed between PSA levels and epithelial volume percentage among the measured samples is unlikely to be coincidental.

Correlations were also determined between PCs and tumor pathological stage. In each of the 199 samples examined, it was observed that PC2 differentiated T2c cancer (prostate-confined; both lobes) from T3 (invading extraprostatic tissue, p<0.03) and T2ab (prostate-confined; one lobe, p<0.005). PC5 was also observed to differentiate T2ab cancer from T2c (p<0.003) and T3 (p<0.00005). PC2 differentiation among tumor stages was again observed to be independent of epithelial content (e.g. T2ab: 21.88±2.59%; T2c: 20.21±1.91%).

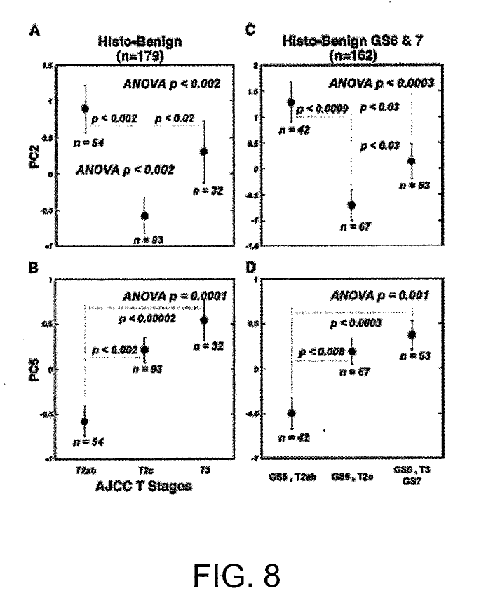

The analysis of the 179 histo-benign samples indicated that similar differentiation between tumor stages could be identified for both PC2 and PC5. FIG. 8A shows a graph that indicates that PC2 can differentiate T2c stage tumors from T2ab and T3 tumors. Similarly, the results shown in the graph of FIG. 8B indicate that PC5 can differentiate T2ab from T2c and T3 stages, as defined by AJCC/TNM staging system (6^{th} ed.). Furthermore, when PC2 and PC5 were correlated with histo-benign samples of GS 6 and GS 7 tumors in 162 samples, both of them were capable of identifying the least aggressive tumor (i.e., GS 6 and T2ab tumors in 42 samples) from those in more aggressive groups (GS 6 T2c, GS 6 T3, and GS 7 tumors). These results for PC2 and PC5 are shown in FIGS. 8C and 8D, respectively.

Tumor perineural invasion status, although not yet incorporated in AJCC/TMN staging, can indicate prostate tumor aggressiveness and may aid treatment planning. However, a tumor heterogeneity can prevent a visualization of an invasion in the biopsy samples. A metabolomic profile analysis yielded a statistically significant correlation between PC 14 levels and invasion status for all 199 samples studied (126 “+” and 73 “−”, p<0.01), the 179 histo-benign samples (103 “+” and 71 “−”, p<0.035), as well as the 42 histo-benign samples from GS 6/T2ab tumors (13 “+” and 29 “−”, p<0.028). This latter observation may have great clinical significance in identifying and managing the less aggressive tumor group within the >70% newly diagnosed moderately differentiated tumors. Details of this analysis are provided, e.g., in Cheng et al., Cancer Res, referenced above.

The strong correlations presented above with respect to tumor pathological stages and perineural invasion represents an indication of the potential for the profile analysis method described herein to improve the current pathology in the diagnosis of prostate cancer. Despite its importance in treatment planning, a tumor pathological stage is presently assessed only by resected prostate tissue. The results described herein suggest that metabolite profiles can provide a “second opinion” for prostate biopsy evaluation. An additional biopsy core, obtained to generate metabolite profiles ex vivo, could also help predict tumor stage for cancer-positive patients, even if the core itself is histo-benign.

The phrase “histo-benign” is used in the description herein, e.g., to highlight that the non-cancer status of the tissue samples studied was determined by an exemplary histological examination. The metabolite results presented herein were analyzed using histopathology, which remains the “gold standard” for cancer diagnosis and treatment planning. The metabolite correlations presented herein and verified using these standard analytical techniques suggest that the metabolomic profile analysis may be performed in accordance with exemplary embodiments of the present invention may be a useful tool in providing improved diagnosis of diseased tissue.

Metabolites measured with tissue MRS can be correlated with histopathology findings, and that metabolite profiles can reveal overall tumor clinicopathological status and aggressiveness before either is visible via histopathology analysis. The results described herein demonstrate the diagnostic and prognostic usefulness of the metabolite protocol.

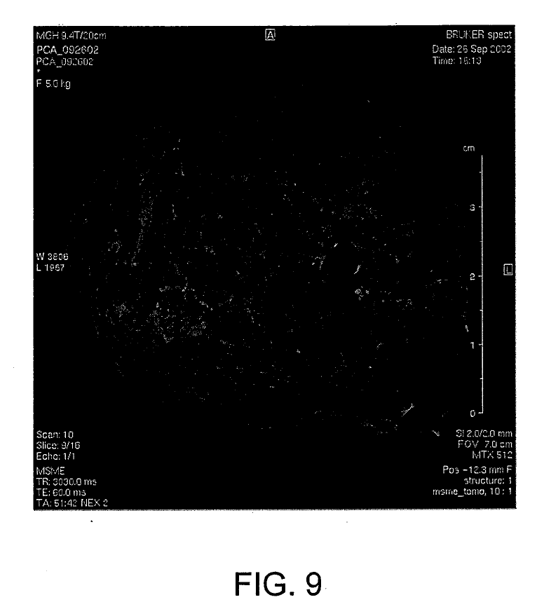

In further exemplary embodiments of the present invention, the system, method and software arrangement according to the present invention described herein may be used to assist pathologists to identify all of the cancerous regions in a surgically removed organ (such as a prostatectomy specimen) to ensure an accurate diagnosis (at least to a large extent). For example, FIG. 9 shows a high-resolution ex vivo image of a cancerous human prostate that is mingled with benign structures, where a morphological image alone may not differentiate cancerous glands from those that are benign. If tissue chemical profiles are obtained using the a system, method and software arrangement in accordance with exemplary embodiments of the present invention, cancerous regions can be highlighted and differentiated from those regions containing benign structures. Such ex vivo analysis can provide valuable information that can be used by pathologist to target histopathological evaluations on the revealed cancerous regions and to ensure all the cancerous regions are histologically analyzed. This degree of analysis may not be achievable using conventional techniques.

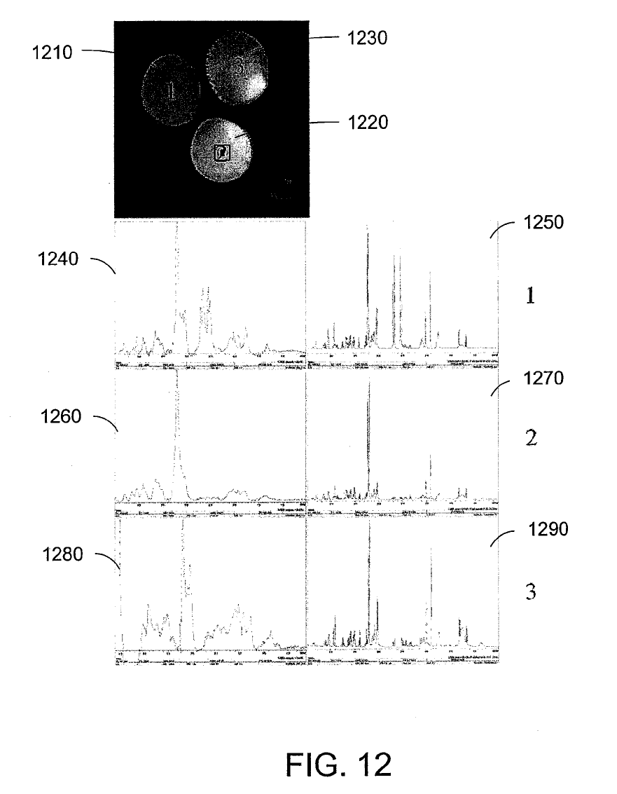

The system, method and software arrangement according to exemplary embodiments of the present invention may be used to achieve in vivo diagnosis of disease. FIG. 12 illustrates a phantom study of three metabolite solutions of varied concentrations that were selected to mimic cancer-related metabolite changes. In this study, a phantom of three spheres 1210, 1220 and 1230 containing these three metabolite solutions (1, 2 and 3) was measured at 9.4 T. The spectrum 1240 of solution 1 measured in vivo at 9.4 T may be compared with the spectrum 1250 of solution 1 measured ex vivo using high-resolution magic angle spinning (HRMAS). Similarly, the spectra 1260, 1280 of solutions 2 and 3, respectively, measured in vivo at 9.4 T may be compared with the spectra 1270, 1290 of these solutions measured ex vivo using high-resolution magic angle spinning (HRMAS). The similarity in the metabolite profiles observed for each in vivo/ex vivo pair suggests that metabolite profiles established with ex vivo analysis can be used to identify metabolites in vivo and to identify regional changes in these metabolites.

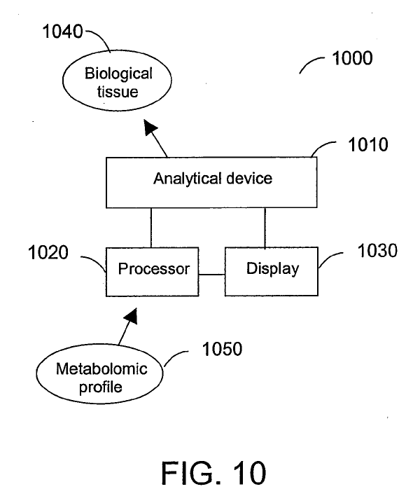

FIG. 10 is a block diagram of one exemplary embodiment of a system according to the present invention that can be configured to diagnose diseases or other bodily conditions based on molecular profiles. In this exemplary embodiment, the system 1000 includes an analytical arrangement 1010. This arrangement 1010 can be any analytical equipment capable of detecting chemical species or metabolites in one or more biological tissues using the techniques described herein such as, but not limited to, magnetic resonance imaging, magnetic resonance spectroscopy, magnetic resonance spectroscopy imaging, chemical shift imaging, genomic based molecular imaging, optical imaging, and/or other radiological or analytical techniques. The analytical arrangement 1010 can also be configured to perform a compositional analysis on the biological tissue 1040. The analysis may be performed with varying degrees of spatial resolution, where the resolution can depend at least in part on the particular analytical technique being performed. The tissue 1040 may be a bodily organ or part or all of a patient's body that is being examined in vivo, and/or an ex vivo tissue such as a removed organ or a biopsy sample. The analytical arrangement 1010 may be configured to detect specific chemical species in the tissue 1040, and/or determine the presence or concentration of various chemical species based on some form of interaction between a generated signal and the biological tissue 1040.

The system 1000 can also include a processor 1020, which may be configured to accept data generated by the analytical arrangement 1010. The processor 1020 can be further configured to perform mathematical operations on this data, for example, to interpret the data or to provide visual representation of the compositions detected in the tissue 1040.

The processor 1020 may be further configured to accept data in the form of one or more metabolic profiles 1050 described above. The processor 1020 may also be configured to perform mathematical operations, such as statistical comparisons between the data received from the analytical device 1010 and the metabolic profile 1050 as described above (that can be stored in a storage arrangement, such as a memory disk, a hard drive, a CD-ROM, etc.). The output of these operations can include correlation coefficients that indicate the degree of matching between the chemical species detected by the analytical arrangement 1010 in the tissue 1040 and the combination of such species specified by the metabolic profile 1050. In certain exemplary embodiments of the present invention, the value of a correlation coefficient can indicate the present or absence of disease or other physiological conditions in the tissue region corresponding to the calculated coefficient. The processor 1020 may be configured to associate a set of such coefficients or similar parameters with specific regions of the biological tissue where data was obtained by the analytical device 1010 to produce the coefficient. The processor 1020 can be configured to perform such operations by executing a software program according to the exemplary embodiment of the present invention thereon.

The processor 1020 can be a separate component that is in communication with the analytical device 1010 or, optionally, it may be part of the analytical device 1010 that can be located in the same housing. The processor 1020 may also include a plurality of individual processors, some or all of which may be associated with the analytical device 1010 and some or all of which may be present as a separate component such as a data analysis module that can be attached to the analytical device 1010.

The system 1000 may also include a display 1030, which can be in communication with the analytical device 1010 and/or the processor 1020. The display 1030 may be configured to accept data directly from the analytical device 1010 or data that has been processed by the processor 1020, and provide visual representations of the various measurements made by the analytical device 1010. These representations can include, e.g., two-dimensional or three-dimensional maps of the tissue 1040, as well as a spatial representation of any signals detected from the tissue 1040 by the analytical device 1010 such as, e.g., chemical species concentrations. The display 1030 can be capable of displaying maps that illustrate the values of correlation coefficients or other calculated parameters described above, overlayed onto corresponding image of the tissue region. Such maps can be displayed as colors in an image of the tissue structure on the display 1030, where certain colors can correspond to particular ranges of the correlation coefficients. Such displays can provide direct visual information revealing the characteristics of various tissue regions as determined by comparison of the local concentrations of various chemical species with one or more of the metabolic profiles 1050. The display 1030 may also provide information in the form of numerical data obtained from the analytical device 1010 and/or the processor 1020.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. In addition, all publications, articles, patents and patent applications cited above are incorporated herein by reference in their entireties.

1. A method for determining at least one characteristic in a biological structure, comprising:
receiving a first information relating to a distribution of at least three chemical species within the structure;
comparing the first information to at least one predetermined profile associated with the at least one characteristic to obtain a second information; and
determining at least one characteristic of the biological structure using the second information.

2. The method according to claim 1, wherein the first information is obtained in vivo from the biological structure.

3. The method according to claim 1, wherein the first information is obtained using a radiological analysis technique.

4. The method according to claim 3, wherein the radiological analysis is at least one of a magnetic resonance imaging technique, a magnetic resonance spectroscopy technique, a magnetic resonance spectroscopy imaging technique, a genomic based molecular imaging technique, an optical imaging technique, or a chemical shift imaging technique.

5. The method according to claim 1, wherein the first information comprises a two-dimensional radiological image.

6. The method according to claim 1, wherein the first information comprises a three-dimensional radiological image.

7. The method according to claim 3, wherein the radiological analysis technique comprises a magnetic resonance spectroscopy imaging technique.

8. The method according to claim 1, wherein at least one of the at least three chemical species comprises a metabolite.

9. The method according to claim 1, wherein the at least one predetermined profile comprises a concentration of at least one of the at least three chemical species.

10. The method according to claim 1, wherein the at least one predetermined profile comprises a linear combination of concentrations of the at least three chemical species.

11. The method according to claim 1, wherein the at least one predetermined profile comprises a ratio of concentrations of at least two of the at least three chemical species.

12. The method according to claim 1, further comprising obtaining ex vivo the predetermined profile via an analysis of at least one of the biological structure or a further biological tissue sample.

13. The method according to claim 12, wherein the analysis of the at least one of the biological structure or the further biological tissue sample comprises a pathological analysis.

14. The method according to claim 12, wherein the analysis of the at least one of the biological structure or the further biological tissue sample further comprises a compositional analysis.

15. The method according to claim 12, wherein the compositional analysis includes at least one of a chemical analysis technique, a magnetic resonance imaging technique, a magnetic resonance spectroscopy technique, a magnetic resonance spectroscopy imaging technique, a genomic based molecular imaging technique, or a chemical shift imaging technique.

16. The method according to claim 1, wherein the second information comprises a statistical correlation between the first information and the at least one predetermined profile.

17. The method according to claim 1, wherein the at least one characteristic includes least one of the presence of diseased biological tissue or the absence of diseased biological tissue.

18. The method according to claim 17, wherein the diseased biological tissue includes cancerous tissue.

19. The method according to claim 17, wherein the second information has the form of a two-dimensional distribution.

20. The method according to claim 17, wherein the second information has the form of a three-dimensional distribution.

21. An executable software arrangement for determining at least one characteristic in a biological structure, comprising:
(a) a first set of instructions which is capable of enabling a processing arrangement to receive first information which is associated with a distribution of at least three chemical species within the structure;
(b) a second set of instructions which is capable of enabling a processing arrangement to compare the first information to at least one predetermined profile associated with the at least one characteristic to obtain a second information; and
(c) a third set of instructions which is capable of enabling a processing arrangement to determine at least one characteristic of the biological structure using the second information.

22. The executable software arrangement according to claim 21, wherein the at least one characteristic includes at least one of the presence of diseased biological tissue or the absence of diseased biological tissue in the biological structure.

23. A system for determining at least one characteristic in a biological structure, comprising a processing arrangement configured to:
receive a first information relating to a distribution of at least three chemical species within the structure;
obtain at least one predetermined profile associated with the at least one characteristic;
compare the first information to the at least one predetermined profile associated with the at least one characteristic to obtain a second information; and
determine at least one characteristic of the biological structure using the second information.

24. The system according to claim 23, wherein the at least one characteristic includes at least one of the presence of diseased biological tissue or the absence of diseased biological tissue in the biological structure.
